(19) United States
(12) Patent Application Publication
(10) Pub. No.: US 2017/0280634 A1
(43) Pub. Date: Oct. 5, 2017

(54) PLANT HOLDER

(71) Applicant: Aaron Tyler, Marlborough, CT (US)

(72) Inventor: Aaron Tyler, Marlborough, CT (US)

(21) Appl. No.: 15/084,244

(22) Filed: Mar. 29, 2016

(51) Int. Cl. A01G 9/02

(52) U.S. Cl. CPC A01G 9/023

(57) ABSTRACT

A plant holder with an elongated column, first and second brackets dimensioned and configured for engaging axial parts of the elongated column, a plurality of arms each having a first axial extremity extending radially from the elongated column at axially parts thereof. Each first extremity of each arm is fixed to the elongated column and each of the arms has an upstanding second axial extremity. An elongated beam has an axial part thereof carried on each of the upstanding second axial extremities of each of the arms in a manner that allows pivotal motion of the elongated beam with respect to the upstanding second axial extremity. First and second receptacles are carried on respective axial extremities of the elongated beam.

### CROSS-REFERENCE TO RELATED APPLICATIONS

### Technical Field

The present invention is generally directed to plant holders. More particularly, the present invention is directed to a plant holder that allows movement of respective plants to optimize, for example, the display of plants or the exposure of respective plants to more or less sunlight.

### BACKGROUND OF THE INVENTION

A wide variety of plant holders are known in the art. Varieties for use indoors and outdoors are known. Many plant holders are particularly adapted for particular applications such as deck railings, cemetery plots and a wide variety of other applications. A limitation of a number of such holders is the inability to move individual plants to optimize the display of the plant and/or expose the plant to more or less sunshine.

### SUMMARY OF THE INVENTION

The shortcomings of the prior art are overcome and additional advantages are provided through a plant holder which includes an elongated column; first and second brackets dimensioned and configured for engaging axial parts of the elongated column; a plurality of arms each having a first axial extremity extending radially from the elongated column at axially parts thereof. Each first extremity of each arm is fixed to the elongated column and each of the arms has an upstanding second axial extremity. An elongated beam has an axial part thereof carried on each of the upstanding second axial extremities of each of the arms in a manner that allows pivotal motion of the elongated beam with respect to the upstanding second axial extremity. First and second receptacles dimensioned and configured for receiving associated potted plant are carried on respective axial extremities of the elongated beam.

In some embodiments the first and second brackets are dimensioned and configured for engaging axial extremities of the elongated column and the brackets are L-shaped. The plant holder may have receptacles that are saucer-shaped. Each of the arms may be L-shaped.

Other embodiments of the present invention include an elongated column and first and second brackets dimensioned and configured for engaging axial parts of the elongated column. Each of the plurality of arms has a first axial extremity extending radially from the elongated column at axially parts thereof, each first extremity of each arm is pivotally attached to the elongated column and each of the arms has an upstanding second axial extremity. An elongated beam has an axial part thereof carried on each of the upstanding second axial extremities of each of the arms in a manner that allows pivotal motion of the elongated beam with respect to the upstanding second axial extremity thereof.

In some embodiments first and second receptacles dimensioned and configured for receiving associated potted plants are carried on respective axial extremities of the elongated beam. The first and second brackets may be dimensioned and configured for engaging axial extremities of the elongated column. The brackets may be L-shaped and the receptacles may be saucer-shaped. Each of the arms may be L-shaped.

Other embodiments of the present invention have a plant holder which includes an elongated column; first and second brackets dimensioned and configured for engaging axial parts of the elongated column; a plurality of arms each having a first axial extremity extending radially from the elongated column at axially parts thereof. Each first extremity of each arm is fixed to the elongated column. Each of the arms has an upstanding second axial extremity. An elongated beam has an axial part thereof carried on each of the upstanding second axial extremities of each of the arms in fixed relationship to the upstanding second axial extremity. First and second receptacles dimensioned and configured for receiving associated potted plants are carried on respective axial extremities of the elongated beam.

In some embodiments of the plant holder the first and second brackets are dimensioned and configured for engaging axial extremities of the elongated column. The brackets may be L-shaped and each receptacle maybe saucer-shaped. In addition each of the arms may be L-shaped.

Accordingly, it is an object of the present invention to provide apparatus which allows a user to easily and rapidly adjust the display of individual plants as well as the exposure of individual plants to more or less sunshine.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The foregoing and other objects, features and advantages of the invention will be apparent from the following more particular description of illustrative embodiments of the invention, as illustrated in the accompanying drawings in which like reference characters refer to the same parts throughout the different views. The drawings are not necessarily to scale, emphasis instead being placed upon illustrating the principles of the invention. Those skilled in the art will understand that the devices and methods specifically described herein and illustrated in the accompanying drawings are non-limiting exemplary embodiments. The features illustrated or described in connection with one exemplary embodiment can be combined with the features of other embodiments. Such modifications and variations are intended to be included within the scope of the present invention.

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a partially schematic side view of one embodiment of the present invention illustrating a vertical column from which first second and third L-shaped arms project in which each support a respective horizontal beam having a saucer-shaped receptacles supported at first and second axial extremities thereof.

FIG. 2 is a partially schematic view illustrating one form of a pivotal connection between one of the arms and one of the beams,

FIG. 3 is a partially schematic broken away view of an embodiment of the present invention in which a journal bearing allows pivotal motion between the vertical column and an L-shaped arm,

FIG. 4 is a bottom view of one form of the saucer-shaped receptacle,

FIG. 5 is a top view of one form of a bracket engaging the lower axial extremity of the vertical column including a blind hole dimensioned and configured for receiving the lower extremity of the column.

### DETAILED DESCRIPTION

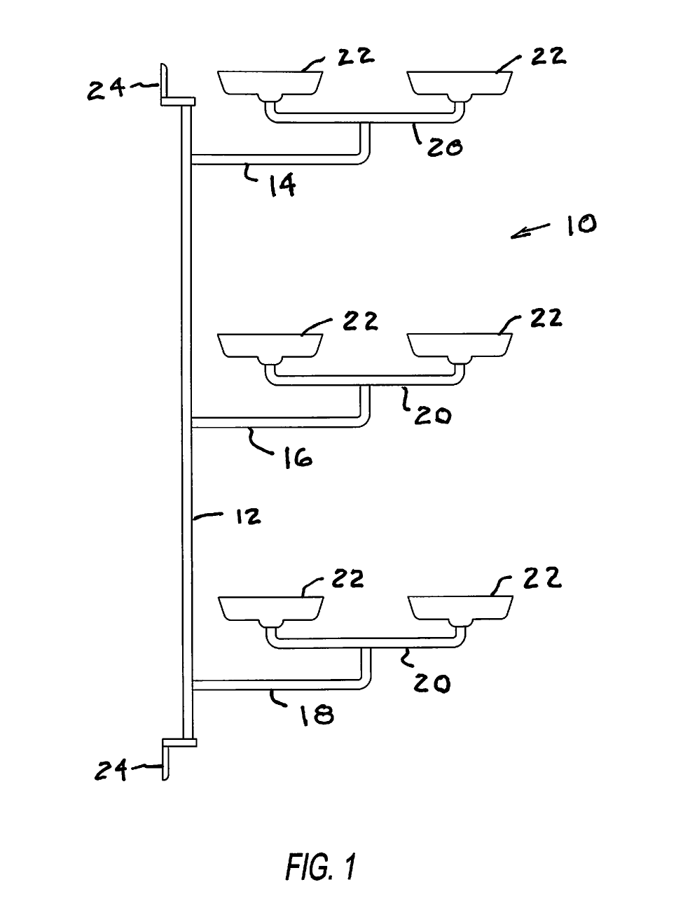

Referring now to FIGS. 1-5 there is shown one embodiment of a plant holder 10 that includes a vertical column 12 from which first second and third L-shaped arms 14, 16, 18 project. Each of the respective first second and third L-shaped arms 14, 16, 18 support a respective horizontal beam 20 having a first and second saucer-shaped receptacles 22 supported at first and second axial extremities of each horizontal beam 20.

The upper and lower axial extremities of the vertical column 12 are supported by respective L-shaped brackets 24. Each L-shaped bracket 24 has a planar face for engaging a planar surface. The planar surface may be a wall or the frame of a window. The choice for the location will often be a function of the sunlight requirements of the plants to be supported by the saucer-shaped receptacles 22. Accordingly, mounting of the plant holder 10 will often be at the frame of a window. Each L-shaped bracket 24 also includes a horizontal part having a blind hole 26 as best seen in FIG. 5. The blind hole 26 is dimensioned and configured for engagement with the column 12. In some embodiments of the present invention there is a slip fit between the column 12 and the blind hole 26 in the bracket 24. Such embodiments enable rotation of the vertical column with respect to the brackets 24 and simultaneous rotation of the respective L-shaped arms 14, 16, 18. Other embodiments may have a welded interface between the column 12 and the blind hole 26 in the bracket 24.

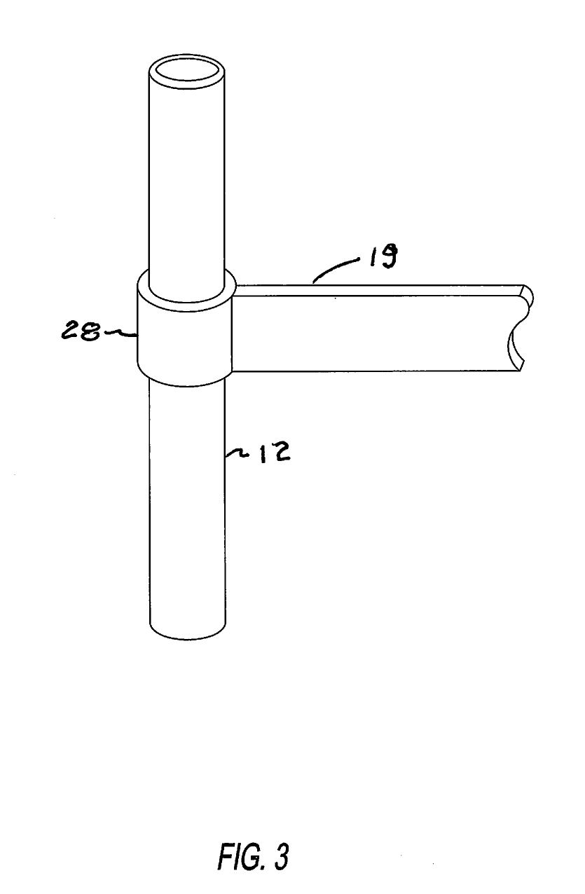

The interface between the L-shaped arms 14, 16, and 18 may be a welded connection. In other embodiments, as best illustrated in FIG. 3 the interface between an L-shaped arm 19 and the column 12 may be a journal bearing that allows rotational movement of the L-shaped arm 19 with respect to the circumferential extent of the column 12.

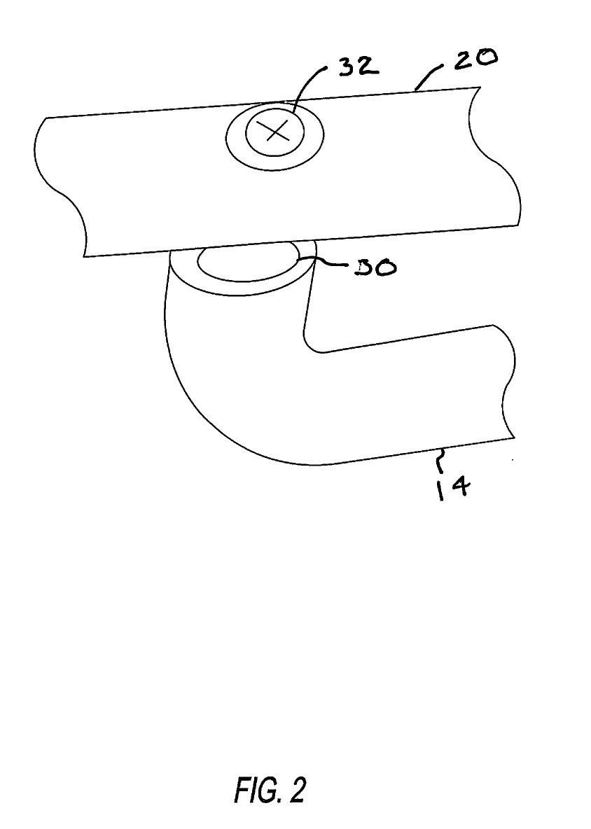

In a similar manner some embodiments of the present invention may have one or more of the respective beams 20 welded to the upstanding axial extremity of an L-shaped arms 14, 16, or 18. In other embodiments as best illustrated in FIG. 2 the upstanding axial extremity of the L-shaped arm 14 includes a pin 32. A slip fit between the pin 32 in the bore 30 allows pivotal motion of the beam 20 with respect to the axial extremity of the arm 14. Those skilled in the art will recognize that some embodiments of the present invention will incorporate the structure described with respect to L-shaped arm 14 will in some embodiments be replicated with respect to the axial extremity of the L-shaped arms 16 and or 18.

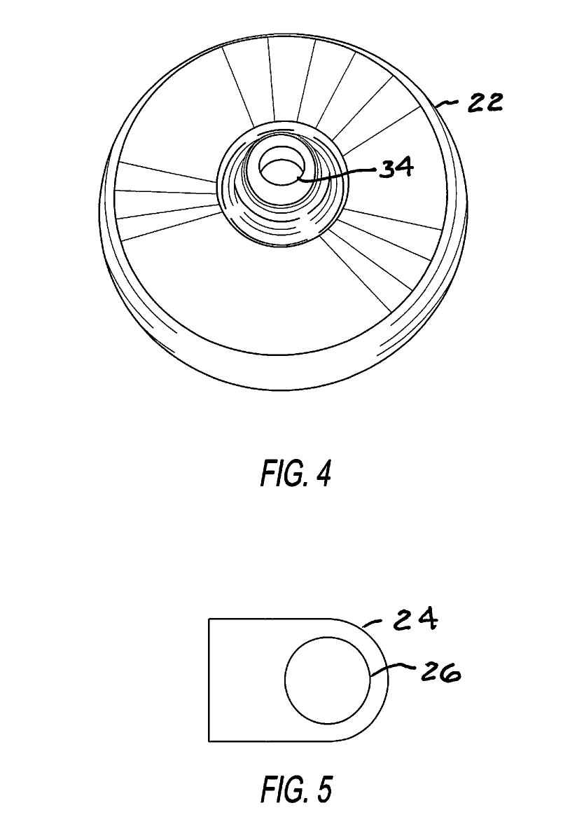

The construction of the saucer-shaped receptacles 22 is further illustrated in FIG. 4. Although the drawings illustrate a receptacle 22 having a generally circular form will be understood that other embodiments may utilize a rectangular or other polygon shape. A central bore 34 cooperates with upstanding axial extremities of the respective beams 20. Some embodiments of the present invention will have the receptacles 22 fixed to the upstanding axial extremities of the respective beams 20. Other embodiments will utilize a slip fit between the upstanding axial extremities of the respective beams 20 and the bore 34 of the respective receptacles 22.

The publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A plant holder which comprises:
an elongated column;
first and second brackets dimensioned and configured for engaging axial parts of said elongated column;
a plurality of arms each having a first axial extremity extending radially from said elongated column at axially parts thereof, each first extremity of each arm being fixed to said elongated column, each of said arms having an upstanding second axial extremity;
an elongated beam having an axial part thereof carried on each of said upstanding second axial extremities of each of said arms in a manner that allows pivotal motion of said elongated beam with respect to said upstanding second axial extremity;
first and second receptacles dimensioned and configured for receiving associated potted plants carried on respective axial extremities of said elongated beam.

2. The plant holder as described in claim 1 wherein said first and second brackets are dimensioned and configured for engaging axial extremities of said elongated column.

3. The plant holder as described in claim 1 wherein said brackets are L-shaped.

4. The plant holder as described in claim 1 wherein each receptacle is saucer-shaped.

5. The plant holder as described in claim 1 wherein each of said arms is L-shaped.

6. A plant holder which comprises:
an elongated column;
first and second brackets dimensioned and configured for engaging axial parts of said elongated column;
a plurality of arms each having a first axial extremity extending radially from said elongated column at axially parts thereof, each first extremity of each arm being pivotally attached to said elongated column, each of said arms having an upstanding second axial extremity;
an elongated beam having an axial part thereof carried on each of said upstanding second axial extremities of each of said arms in a manner that allows pivotal motion of said elongated beam with respect to said upstanding second axial extremity;
first and second receptacles dimensioned and configured for receiving associated potted plants carried on respective axial extremities of said elongated beam.

7. The plant holder as described in claim 6 wherein said first and second brackets are dimensioned and configured for engaging axial extremities of said elongated column.

8. The plant holder as described in claim 6 wherein said brackets are L-shaped.

9. The plant holder as described in claim 6 wherein each receptacle is saucer-shaped.

10. The plant holder as described in claim 6 wherein each of said arms is L-shaped.

11. A plant holder which comprises:
an elongated column;
first and second brackets dimensioned and configured for engaging axial parts of said elongated column;
a plurality of arms each having a first axial extremity extending radially from said elongated column at axially parts thereof, each first extremity of each arm being fixed to said elongated column, each of said arms having an upstanding second axial extremity;
an elongated beam having an axial part thereof carried on each of said upstanding second axial extremities of each of said arms in fixed relationship to said upstanding second axial extremity;
first and second receptacles dimensioned and configured for receiving associated potted plants carried on respective axial extremities of said elongated beam.

12. The plant holder as described in claim 11 wherein said first and second brackets are dimensioned and configured for engaging axial extremities of said elongated column.

13. The plant holder as described in claim 11 wherein said brackets are L-shaped.

14. The plant holder as described in claim 11 wherein each receptacle is saucer-shaped.

15. The plant holder as described in claim 11 wherein each of said arms is L-shaped.
